(19) United States
(12) Patent Application Publication
(10) Pub. No.: US 2007/0110543 A1
(43) Pub. Date: May 17, 2007

(54) Tail-driven screw fastener for use in tamper-resistant and decorative applications

(76) Inventor: Christopher Milton Fitch, Arlington, MA (US)

Correspondence Address: CHRISTOPHER M. FITCH, 23 JASON ST., ARLINGTON, MA, 02476, US

(21) Appl. No.: 11/595,773

(22) Filed: Nov. 11, 2006

Related U.S. Application Data
(60) Provisional application No. 60/735,380, filed on Nov. 12, 2005.

(51) Int. Cl. F16B 25/00

(52) U.S. Cl. 411/386

(57) ABSTRACT

A threaded fastener with unique tamperproof and decorative qualities comprised of a cylindrical body with helical threads (1) in combination with a non-torqueable head (2,5,7,8) at one end and a torqueable access located on the tail, or insertion, end (3,9,10). The lack of a drive access in the head of the screw creates a tamperproof surface which can be treated decoratively (7,8), ground, polished, or painted. Although tamperproof from the head side of the screw, standard torqueable access in the tail end makes the screw nevertheless easy to remove for servicing.

### CROSS-REFERENCE TO RELATED APPLICATIONS

This application is entitled to the benefit of Provisional Patent Application Ser. No. 60/735,380 filed 2005, Nov. 12 by the present inventor.

### FEDERALLY SPONSORED RESEARCH

n/a

### SEQUENCE LISTING OR PROGRAM

n/a

### BACKGROUND

1. Field of Invention

This invention relates to threaded fasteners of the bolt or machine screw variety, specifically to such fasteners that have tamper-resistant or decorative functions associated with them.

2. Discussion of Prior Art

As I was involved in a project that required tamper-resistant screws, I became aware of the limitations of the options that are currently commercially available. Most depend on one of the following strategies to discourage people from undoing screws. The first involves a driver shape that is unusual and hard to improvise. Examples of this type include the star-shaped drive Torx Plus TM, triangular drive, or spanner drive style screws. All of these mate with specialized drivers. Other screws are designed to be driven in one direction only, such as the non-reversible slotted screw style. Another strategy has been to drive blank caps over the heads of screws once they have been fixed in their final positions. These caps are designed to be driven on easily with a hammer blow, but do not come off easily. There have also been more complex designs of fasteners with heads that spin, or with collars that spin, or with special drivers that clamp onto special shoulders under the head. In all cases, however, the driving force for setting the screws in their final position is applied at the heads of the screws.

Those examples of prior art where driving access is provided at the tail, or insertion end, of the fastener do so specifically for reasons other than the objectives described for the current invention. For instance, Kreider 3,041,912 and Wing 2,940,495 describe fastening systems with cooperating members such as grommets or frangible portions with which those inventions are primarily concerned and do not teach any advantages to head design for tamper resistance, labeling or decoration. Salz 3,329,057 and Pumphrey 2,388,658 both disclose a slot at the tail end of their fasteners, but for Pumphrey, its purpose is specifically for turning his fastener 90 degrees to engage its head into a square hole and does not teach anything about driving from the tail end or tamper-resistance. Salz's invention is focused specifically upon the design of the slot such that the screw can be held steady while a nut is power-driven into place and teaches nothing about tamper-resistant or decorative applications or about how to create a finished surface on the head. Smith 755,804 discloses a decorative screw, but one which is still driven from the head and not the tail.

### OBJECTS AND ADVANTAGES

My invention discloses a machine screw with a non-torqueable head in combination with a torqueable access in the tail, or insertion, end of the screw. Currently there are no such fasteners on the market of which, after a careful search, I am aware, and yet the need for secure and decorative fastening systems is ever more pressing as both the security and design industries are currently burgeoning, and promise to continue to do so. As our society becomes ever more security-conscious, new ways of providing security are always in demand. With tail-driven fasteners, a manufacturer can present to a consumer a product with no clear path to disassembly. The advantages of such a combination in a screw fastener are multi fold:
A. By virtue of the fact that the driving location for the screw is away from view, there is no obvious way to unscrew it for the average lay person given any kind of driver at all, specialty or otherwise.
B. Yet, because its tamper-resistance relies on the position of the driving access, as opposed to the style of the drive, it can be made to work with any commonly available drive style. This allows easy assembly without specialized equipment.
C. Relieved from the function of providing a drive access location, the head of the screw is provided alternative opportunities to be ornamental, decorative, or functional in other ways and can be camouflaged in its surroundings.
D. Fasteners can be manufactured to existing standards with existing capabilities at minimal, if any, additional set up cost.

My invention takes an ordinary machine screw and reorganizes its functional components in a new, unobvious, and useful way. Normal machine screws are driven from their heads into their working positions. My invention describes a means and a method to drive machine screws from their tails into position and use their heads for other purposes than providing a torqueable access. By torqueable access I mean a recess or projection shaped to receive a matingly shaped member on a driving tool. In the same fashion that the female driving access of a set screw is recessed into its threaded shaft, my invention features a female driving access in the threaded shaft of its tail, or insertion, end. Alternatively, the access can be shaped in relief, creating a male torqueable access. Any drive style that is currently available or may in the future be available that is appropriate for set screws, therefore, would be appropriate for similar reasons in my invention. Currently available drive styles for such purpose include, but are not limited to, hex (or Allen), slotted, square (Robertson), or star-shaped drives (like Torx TM or Torx Plus TM).

My invention requires no significant changes in existing manufacturing technology to be made commercially available. The fact that my invention can be manufactured on existing equipment to existing standards, and satisfies existing needs is a major advantage in a fast-paced marketplace and adds to its status as a commercially viable product.

Not only can tail-driven fasteners present a blank face to the tamper-tempted individual, but having been relieved of their function as driving members, their faces are free to perform other duties. Screws often present an aesthetic challenge to engineers and designers. Given a design objective of having an assembly that has a clean look, screw heads can often be viewed negatively if they are too visible. Two preferred embodiments of my invention allow the possibility of screw heads that are perfectly clean in appearance, with a polished look, either flat-headed or round-headed with no indentations or recesses. Such screw heads would present a distinguished, elegant appearance and could very well be seen as decorative elements in their own right. Furthermore, the possibility is created to make screw heads decorative in any style or shape or material whatsoever. Some design ideas that come to mind are rounded cones, pyramids, stars, flowers, stamped or molded, etched or printed designs, or blank versions of otherwise standard screw head shapes.

Beyond serving a decorative function, unusual head designs, such as those above described, can add the further benefit of camouflaging the screws. Screws can be made with specially designed heads that match existing patterns on surfaces, for example. Or they can simply pose as ornaments themselves without betraying their hidden functional purpose. Another preferred embodiment is to number the heads of the screws, so that parts can be labeled, or assembly order can be established, or so that individual screws can be kept organized during servicing or manufacture, for example, or for any other reason. Screw heads can be etched or printed with logos, color-coded, or provide a surface for custom alteration and individual expression.

Once assembled into its component, the head of the fastener can be shaped, ground, polished, painted, etc., as if it were part of the surface of the component into which it has been assembled, with no loss of utility. Fasteners with torqueable access in their heads might lose that access if they were ground, shaped, or painted. With my invention, the drive access would remain intact, protected, and unaffected at the tail end of the screw. Grinding and polishing or painting the head of a machine screw would allow it to blend seamlessly into the background component. This would have usefulness not only for security, but also in any application in which a seamless surface is desired, such as the aerospace industry, marine industry, and for high-end design or architectural components.

### SUMMARY

In accordance with the present invention, a threaded fastener comprises a non-torqueable head in combination with a torqueable access in the tail, or insertion, end of the fastener such that its head is made tamperproof, decorative, or seamless with its surroundings.

### DESCRIPTION OF DRAWINGS

Drawing Figures:

There are ten depicted figures of preferred embodiments of the present invention.

FIGS. 1 to 3 show various views of an unornamented flat-headed machine screw with no torqueable access in its head and a hexagonally shaped torqueable access in its tail.

FIGS. 4 to 6 show various views of a machine screw with a spherical-sectional or round head, unornamented and with no torqueable access and with a hexagonally shaped torqueable access in the tail.

FIG. 7 shows a threaded fastener with a pancake-shaped head with no torqueable access and instead with a stamped, molded, or embossed pattern, in this case a number.

FIG. 8 shows a threaded fastener with a pancake-shaped head with no torqueable access and instead with a stamped, molded, or embossed pattern, in this case a flower pattern in relief.

FIG. 9 shows the flat-headed machine screw of FIGS. 1 to 3, but with a slotted instead of hexagonal torqueable access in its tail.

FIG. 10 shows the flat-headed machine screw of FIGS. 1 to 3, but with a square instead of hexagonal torqueable access in its tail.

### REFERENCE NUMERALS IN DRAWINGS

1 Threaded screw body
2 Blank flat head
3 Hexagonal torqueable access
4 Beveled underside of flat head
5 Blank spherical-sectional or round head
6 Flat underside of spherical-sectional or round head
7 Example of numbered head
8 Example of decorative head
9 Slotted torqueable access
10 Square torqueable access

### Specifications

### DETAILED DESCRIPTION OF INVENTION

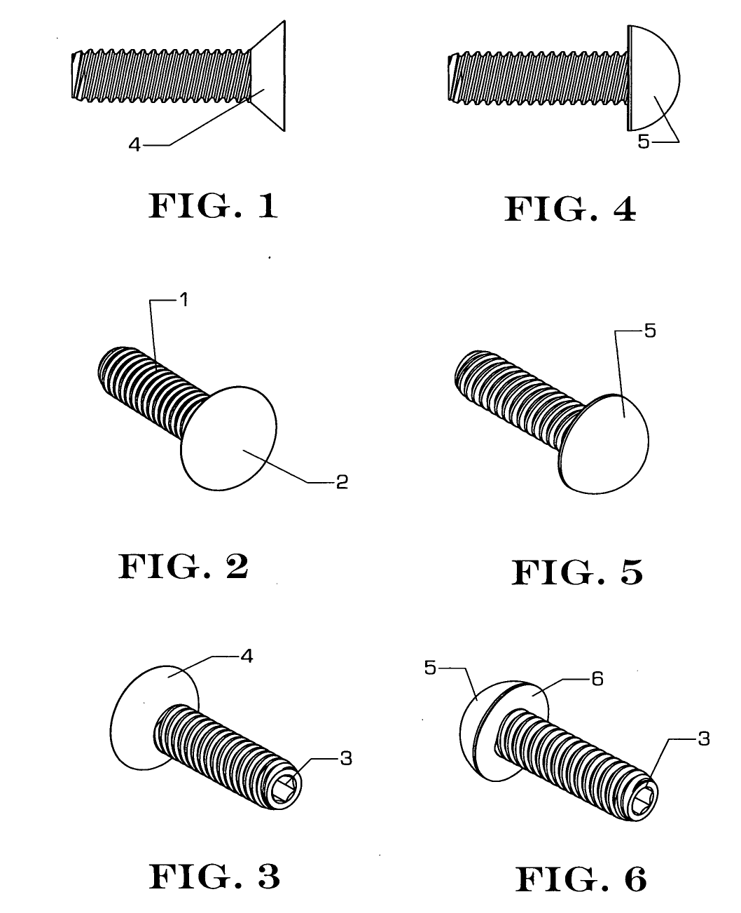

### PREFERRED EMBODIMENT—FIGS. 1 TO 3

A preferred embodiment of the present invention is illustrated in FIGS. 1 to 3. In these illustrations, an embodiment is described wherein the invention resembles a common flat head machine screw. Where it differs, however, is in the placement of the drive access. In my invention, the access for torquing, or driving, the screw is found not in the head 2 but in the tail 3, or insertion end of the screw. FIG. 1 shows a side view of the screw. FIG. 2 shows an isometric view from the head end of the screw. FIG. 3 shows an isometric view from the tail end of the screw.

The preferred embodiment has a helical thread 1 that wraps around the body of the screw in any currently or future available standard or custom industrial screw thread size. The current invention is not concerned with screw thread design per se. Likewise, my invention is not focused on the issue of material selection per se, and any material that screws can be made from generally will suffice, although a tough, hard material such as hardened steel alloy will provide the best characteristics for torquing without stripping the drive socket. Also, for some applications it may be desirable to choose a material that corresponds to the surrounding surface material in the parts to be joined. Such might be the case, for instance, if one wanted to grind the head flush with the surrounding material to create a seamless surface. Aluminum would be a good choice for such an operation, where the surrounding material is also aluminum, because of its good blending and polishing characteristics. Material choices can thus be decided on an individual basis depending on specific application needs.

The preferred embodiment in FIGS. 1 to 3 depicted shows an inward bevel on the back surface 4 of the screw head. As depicted, the bevel describes an angle of 82 degrees. This is a commonly available standard bevel angle for flat head machine screws and is intended to mate with a similarly angled bevel in a countersunk hole in the material to be fastened. Any current or future available standard or custom bevel angle is permissible. Other angles commonly found are 90 degrees and 60 degrees, for example.

The top or front surface 2 of the screw head in the preferred embodiment as depicted in FIG. 2 is flat and unornamented. As such it can function unaltered, or it can be used as a base for further treatment. Examples of further treatment include, but are not limited to, being textured, printed, etched, anodized, punched, embossed, stenciled, painted, ground, or polished.

The tail or insertion end of the screw in the preferred embodiment as depicted in FIG. 3 features a hexagonal socket 3 for a torqueable drive access. Because the hexagonal style of socket drive is the most commonly used style in set screws, and because the driving end of a set screw is analogous to the insertion end of my invention, it provides a convenient standard for use in the preferred embodiment of my invention. Furthermore, it ensures that existing technology can be readily adapted to manufacture the screws and that standard tooling can be used for their installation.

### ADDITIONAL PREFERRED EMBODIMENT—FIGS. 4 TO 6

An additional preferred embodiment is illustrated in FIGS. 4 to 6. This embodiment is structurally similar to that depicted in FIGS. 1 to 3 with one exception, in that it features a sectional-spherical (dome-shaped or round) head 5 with a flat back surface 6 that flushly contacts the surface surrounding the hole in the material to be fastened without countersinking the hole.

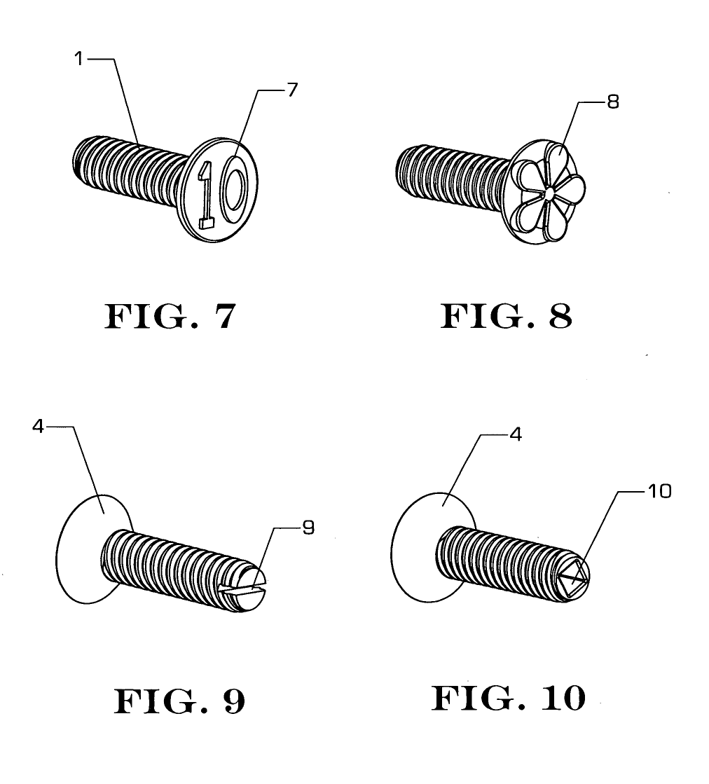

### ALTERNATIVE EMBODIMENTS—FIGS. 7 TO 10

There are literally limitless possibilities in head design. Two examples are provided in FIGS. 7 and 8. FIG. 7 illustrates a numbered head 7. FIG. 8 illustrates a head featuring an embossed floral design 8. Numbers or other labels or patterns can be stamped, embossed, molded, punched, printed, etched, machined, anodized, enameled, or created with any other current or future applicable technique. Colors may be added, and disparate materials may be combined. For example, different metals may be inlaid with each other, or plastics or resin surfaces may be combined with metals or with any other applicable material to create deep patterns that are retained even after being ground flush with surrounding surfaces.

Two examples of alternative embodiments for the design of the torqueable access points on the tail end of the screw are also provided in FIGS. 9 and 10. These two examples show a slotted access 9 and square (or Robertson style) access 10. It is to be understood, however, that any drive style that might be considered appropriate for set screws would likewise be considered appropriate for the present application. Although the depicted tails all have recessed accesses, which is the preferred embodiment, there is also the possibility of having drives that extend outward from the face of the tail end of the screw. Any shape that can be imagined recessed can also be reversed into a positive shape that can be driven by a driver with a mating recess.

I have not specified any particular angle or pitch of thread, because the scope of the invention is not interested in such particulars of thread design.

### Operation of Invention

Normally, machine screws are driven from their heads, using specially shaped recesses or projections that engage mating shapes on appropriate driving tools. In my invention, the machine screws are driven from their tails. This means that an operator must reach the driving tool through the hole into which the screw is to be driven, engage the torqueable recess (3,9,10), guiding the screw into the hole, and rotate in a direction appropriate to the direction of the screw threads 1. The screw can also be started by hand and torqued with a driver as it approaches its final position. Typically, right-handed threads therefore would be driven toward the driver in a counterclockwise direction for tightening, and in a clockwise direction for loosening. Access to the underside of the assembly is necessary until assembly is completed. Once in place, further operations can be performed on the head, such as grinding, polishing, painting, or finishing in any other way.

### CONCLUSION, RAMIFICATIONS, AND SCOPE OF INVENTION

As the reader can ascertain, the invention of the tail-driven machine screw has a definite place in the pantheon of available fasteners. It is a device that is easily manufactured using existing manufacturing technology to existing standards of quality. It is easy to operate using a variety of available drive styles. It provides a strong secure connection between machined parts. And it opens up the possibility of a whole family of fasteners that have the additional following advantages:
Being driven from the tail affords the screws an unparalleled level of security. There is no torqueable drive access at the head of the screw, which is usually the part that faces the end user of an assembled component. Tampering is thereby aggressively discouraged.
Having been relieved of its usual function of providing a drive location, the screw head is allowed to function in new ways. These new ways can either be decorative or functional.
Functionally, the head can provide an additional level of tamper resistance through camouflage, by either blending into a background pattern on the component in which it is being used, by disguising itself as an ornament, or by presenting a blank face which may be passed over as simply part of the component other than as a fastener.
Once assembled into its component, the head of the fastener can be shaped, ground, polished, painted, or otherwise finished as if it were part of the surface of the component into which it has been assembled with no loss of utility.
Any kind of shape, image, number, letter or part label can be printed, machined, stamped, molded, embossed or otherwise formed, colored, or created from a combination of materials on the visible side of the head, allowing it to be used not only for fastening, but for decorative and informative purposes, as well.

Although the description above contains many specificities, these should not be construed as limiting the scope of the invention but as merely providing illustrations of some of the presently preferred embodiments of this invention. Any threaded fastener that combines a non-torqueable head with a torqueable access in its tail should be taught by this invention, regardless of the type of drive or of the specific design or shape of its head.

Thus, the scope of the invention should be determined by the appended claims and their legal equivalents, rather than by the examples given.

I claim:

1. A threaded fastener comprising, in combination:
(a) a substantially cylindrical body with helical threads
(b) a non-torqueable head at one end of said cylindrical body
(c) a torqueable access located on the insertion end of said cylindrical body opposite said non-torqueable head, whereby said fastener creates unique tamper-resistant and decorative application opportunities to the user.

2. The fastener of claim 1 wherein the underside of said head is of a shape that can be recessed into a mating negative shape in the material to be fastened.

3. The fastener of claim 2 wherein at least said head is comprised of a material that can be ground smooth.

4. The fastener of claim 3 wherein said material is comprised of a plurality of dissimilar materials forming an inlaid pattern.

5. The fastener of claim 1 wherein the underside of said head radiates perpendicularly from the axis of said cylindrical body such that said head is in flat contact with the outer surface of the material to be fastened.

6. The fastener of claim 1 wherein said torqueable access is recessed into the end of said cylindrical body such that said access can be torqueably engaged with a driver with a mating positive shape.

7. The fastener of claim 6 wherein said torqueable access is of a polygonal cross-section.

8. The fastener of claim 7 wherein said torqueable access is of a substantially hexagonal cross-section.

9. The fastener of claim 1 wherein said torqueable access protrudes from the end of said cylindrical body such that said access can be torqueably engaged with a driver with a mating negative shape.

10. A method of fastening two or more adjacent materials comprising:
(a) providing a threaded fastener comprising a substantially cylindrical body with helical threads, a non-torqueable head at one end of said cylindrical body, a torqueable access located on the insertion end of said cylindrical body opposite to said non-torqueable head,
(b) inserting said fastener through openings in a plurality of materials, one or more of said openings having helical threads mating with the threads on said cylindrical body,
(c) engaging a driving tool with said torqueable access, said driving tool having a cross-sectional shape that mates with said access,
(d) rotating said fastener using said driving tool,
whereby said fastener is drawn into said mating threads in said material,
whereby said fastener provides a decorative and tamperproof head and protected drive access.

11. The method of claim 10 wherein the underside of said head is of a shape that can be recessed into a mating negative shape in the material to be fastened.

12. The method of claim 11 wherein at least said head is comprised of a material that can be ground smooth.

13. The method of claim 12 wherein said material is comprised of a plurality of dissimilar materials forming an inlaid pattern.

14. The method of claim 10 wherein the underside of said head extends perpendicularly from the axis of said cylindrical body such that said head comes into flat contact with the outer surface of the material to be fastened.

15. The method of claim 10 wherein said torqueable access is recessed into the end of said cylindrical body such that said access can be torqueably engaged with a driver with a mating positive shape.

16. The method of claim 15 wherein said torqueable access is of a polygonal cross-section.

17. The method of claim 16 wherein said torqueable access is of a substantially hexagonal cross-section.

18. The method of claim 10 wherein said torqueable access protrudes from the end of said cylindrical body such that said access can be torqueably engaged with a driver with a mating negative shape.

19. In order to serve the need for decorative tamperproof screws, a means for providing a non-torqueable head on a threaded fastener, wherein a torqueable access is located on the insertion, or tail, end of said threaded fastener.

20. The means of claim 19 wherein at least said head is comprised of a material or a plurality of dissimilar materials forming an inlaid pattern that can be ground flush with surrounding surfaces.
